(19) United States
(12) Patent Application Publication
(10) Pub. No.: US 2014/0269198 A1
(43) Pub. Date: Sep. 18, 2014

(54) Beamforming Sensor Nodes And Associated Systems

(71) Applicant: The Trustees of Dartmouth College, Hanover, NH (US)

(72) Inventors: Laura Ray, Hanover, NH (US); Alaa Abdeen, Hanover, NH (US)

(73) Assignee: The Trustees of Dartmouth College, Hanover, NH (US)

(21) Appl. No.: 13/835,301

(22) Filed: Mar. 15, 2013

(51) Int. Cl. G01S 3/808

(52) U.S. Cl. CPC G01S 3/808
USPC 367/123

(57) ABSTRACT

A beamforming sensor node has an array of pressure wave sensors and beamforming circuitry. Each pressure wave sensor is configured within a unique processing channel including a time delay circuit for producing a signal, with a phase offset, representative of received pressure waves at said pressure wave sensor. The beamforming circuitry includes the time delay circuits for all processing channels and (a) sets the phase offset of each processing channel and (b) parallel processes all signals from the array of pressure wave sensors through respective time delay circuits to form a first coherent beam-formed signal from the node. A secondary beamforming node combines coherent beam-formed signals from the plurality of sensor nodes to produce a combined acoustic signal representative of received pressure waves at all sensor nodes.

### U.S. GOVERNMENT RIGHTS

This invention was made with government support under FA9550-08-1-0366 awarded by the Air Force Office of Scientific Research and government support under IIP-1312440 awarded by the National Science Foundation. The government has certain rights in the invention.

### FIELD OF THE INVENTION

A sensor node beamforms signals from an array of sensors, such as microphones or ultrasonic transducers, and estimates delays between signal paths of any pair of sensors to coherently add and relay the beamformed signal.

### BACKGROUND

Beamforming is a signal processing technique for increasing signal-to-noise ratio (SNR) through directional or spatial selectivity of signals transmitted through an array of antennae or transducers or received from an array of sensors. Beamforming increases the sensitivity to signals in a specified direction and location in space while reducing sensitivity to signals from other directions/locations. Consequently, beamforming provides signal enhancement, as well as spatial filtering. Digital beamforming systems employ adaptive filters to reduce noise and shape sensor signals to minimize sidelobes and improve directivity and signal-to-noise ratio.

Prior beamforming systems suffer from lack of scalability; as the number of channels increases, the complexity of the computations required to add the signals coherently grows, as each channel must be correlated with each other channel, shifted in time, and summed. The complexity of estimating time delays using adaptive filters also grows. Existing systems for beamforming generally use digital signal processors but are limited in throughput by the speed of the processor, the capacity and throughput of the data bus, and the number of input/output channels the DSP device may accommodate. Accordingly, prior beamforming systems have generally been limited to a few channels in order to permit real-time processing. And, for a large number of channels, processing the beamform is not performed in real time.

Devices for beamforming ultrasonic arrays typically use multiple graphics processing units (GPUs) to achieve throughput with a large number of channels. These devices have the disadvantage of high power consumption, and may require cooling.

### SUMMARY OF THE INVENTION

In an embodiment, a beamforming sensor node has an array of pressure wave sensors and beamforming circuitry. Each pressure wave sensor is configured within a unique processing channel including a time delay circuit for producing a signal, with a phase offset, representative of received pressure waves at said pressure wave sensor. The beamforming circuitry includes the time delay circuits for all processing channels and (a) sets the phase offset of each processing channel and (b) parallel processes all signals from the array of pressure wave sensors through respective time delay circuits to form a first coherent beam-formed signal from the node.

In another embodiment, a pressure wave binocular has a plurality of sensor nodes and a secondary beamforming node. Each sensor node has beamforming circuitry and an array of pressure wave sensors. Each pressure wave sensor is configured within a unique processing channel that includes a time delay circuit for producing a signal, with a phase offset, representative of received pressure waves at said pressure wave sensor. The beamforming circuitry includes time delay circuits for all processing channels, for (a) setting the phase offset of each processing channel and (b) parallel processing all signals from the array of pressure wave sensors through respective time delay circuits to form a coherent beam-formed signal from the node. The secondary beamforming node combines coherent beam-formed signals from the plurality of sensor nodes to produce a combined acoustic signal representative of received pressure waves at all sensor nodes.

In another embodiment, a beamforming acoustic binocular node includes a smartphone with (a) an array of acoustic sensors, where each acoustic sensor is configured within a unique processing channel that includes a time delay circuit for producing a signal, with a phase offset, representative of received sounds at said acoustic sensor, and (b) beamforming circuitry, including time delay circuits for all processing channels, for (i) setting the phase offset of each processing channel and (ii) parallel processing all signals from the array of acoustic sensors through respective time delay circuits to form a first coherent beam-formed signal from the node.

In another embodiment, a social acoustic beamforming system includes a plurality of smartphones and at least one secondary beamforming node. Each of the smartphones includes beamforming circuitry and an array of acoustic sensors. Each acoustic sensor is configured within a unique processing channel that includes a time delay circuit for producing a signal, with a phase offset, representative of received sounds at said acoustic sensor. The beamforming circuitry includes time delay circuits for all processing channels and (a) sets the phase offset of each processing channel and (b) parallel processing all signals from the array of acoustic sensors through respective time delay circuits to form a first coherent beam-formed signal from the node. The secondary beamforming node combines all coherent beam-formed signals from the plurality of smartphones to produce a combined acoustic signal representative of received acoustic waves at all smartphones.

### BRIEF DESCRIPTION OF THE FIGURES

FIG. 1 shows one exemplary beamforming sensor node, in an embodiment.

FIG. 2 shows one exemplary physical implementation of a beamforming sensor node with the sensor array configured with circular geometry, in an embodiment.

FIG. 3 is block diagram showing a distributed parallel beamforming system configured with four sensor nodes and a secondary beamforming node, in an embodiment.

FIG. 4 is a schematic showing a distributed parallel beamforming system with sixteen sensor nodes, four secondary beamforming nodes, and a tertiary beamforming node, in an embodiment.

FIG. 5 is a schematic showing one exemplary signal processing path for processing signals from a single sensor.

FIG. 6 is a schematic showing one exemplary Least Mean Square (LMS) filter for estimating delay between two signals from pressure wave sensors, in an embodiment.

FIG. 7 is a schematic showing one exemplary signal processing path configured with an LMS filter for estimating the delay between two signals, in an embodiment.

FIG. 8 shows a first graph where lines represent a first raw recorded data signal and a delayed second raw recorded data signal and a second graph showing exemplary results of using an LMS filter to estimate the delay between the two data signals, in an embodiment.

FIG. 9 shows one exemplary signal processing path incorporating an LMS filter for estimating a delay between two signals, in an embodiment.

FIG. 10 shows exemplary circular Microphone Array Beam-patterns for Selected Frequencies and Radii.

FIG. 11 is a table showing exemplary sample delays for a single beam direction (10, 90 degrees) for a sensor array configured with a 10 cm radius, in an embodiment.

FIG. 12 shows one exemplary Microphone Preamplifier and ADC Anti-aliasing Filter, in an embodiment.

FIG. 13 shows one exemplary Precision Reference Voltage Circuit, in an embodiment.

FIG. 14 shows one exemplary Analog-to-Digital Converter Circuit, in an embodiment.

FIG. 15 shows one exemplary Analog-to-Digital Converter Reference Voltage Circuit, in an embodiment.

FIG. 16 shows exemplary Digital Buffers for certain ADC Common Control Signals, in an embodiment.

FIG. 17 shows one beamforming sensor node and a speaker, in an embodiment.

FIG. 18 shows two beamforming sensor nodes and a speaker, in an embodiment.

FIG. 19 shows exemplary determination of beam angles and distances for a beamforming system operating as an acoustic binocular, in an embodiment.

FIG. 20 shows one exemplary system for enhancing sound collection, in an embodiment.

### DETAILED DESCRIPTION OF THE EMBODIMENTS

The following describes select embodiments of the beamforming system and devices for parallel, distributed beamforming. FIG. 1 shows one exemplary beamforming sensor node 100. Beamforming sensor node 100 generates, from sensor signals collected from pressure wave sensors 120 formed into a sensor array 101, a beamformed signal 110 that may be transmitted to a second computational device (see for example secondary beamforming node 302 of FIG. 3) or optionally output and used locally to the sensor node. FIG. 2 shows one exemplary physical embodiment of beamforming sensor node 100 with sensor array 101 configured in circular geometry.

Beamforming sensor node 100 includes a plurality of processing channels 102, each with a pressure wave sensor 120, gain circuitry 122, signal conditioning circuitry 124 and a digital-to-analog converter 126. A signal from each pressure wave sensor 120 is conditioned through analog circuitry of gain circuitry 122 and signal conditioning circuitry 124 (see for example FIGS. 12-16) and then digitized, using analog-to-digital converter (ADC) 126, to form a digital signal 103. Signals from each pressure wave sensor 120 are digitized in parallel through their respective ADC, as for example shown in FIG. 14. Digital signals 103 are processed by a beamforming circuitry 108 that includes parallel data transmission paths (e.g., implemented using digital signal processing (DSP) such as provided by a field programmable gate array (FPGA) or application specific integrated circuit (ASIC)) to beamform a plurality of digital signals 103 into a single coherent beamformed signal 110. For each processing channel 102, beamforming circuitry 108 includes a delay circuit 104 that operates to provide a controllable delay to digital signal 103. Delay circuit 104 is for example implemented as a buffer, such as discussed below in greater detail with respect to FIG. 5. Beamforming circuitry 108 also includes a summer 128 that sums delayed signals from delay circuits 104 to form coherent beamformed signal 110.

Coherent beamformed signal 110 may be output by a communication module 130 (e.g., as facilitated by a microcontroller or core of the DSP) that broadcasts, by wire or wirelessly, beamformed signal 110 from beamforming sensor node 100 to a second computational device, such as a computer, another beamforming sensor node, a DSP, a microcontroller, and an FPGA or ASIC signal processor of the same type used to implement beamforming circuitry 108. In one embodiment, communication module 130 is a wireless transducer that operates externally to beamforming sensor node 100.

FIG. 3 shows one exemplary distributed beamforming system 300 with a secondary beamforming node 302 and four beamforming sensor nodes 304(1)-(4) that each includes a plurality of processing channels 102 and at least one beam forming node 108. Where secondary beamforming node 302 represents the second computational device described above, it also contains a beamforming circuitry 108 that receives coherent beamformed signals 110 from each of a plurality of beamforming sensor nodes 304. Beamforming circuitry 108 within secondary beamforming node 302 operates to further beamform received beamformed signals 110 into a second single coherent beamformed signal 310 with increased signal-to-noise ratio. Secondary beamforming nodes 302 may be further cascaded to provide a scalable system comprised of multiple processing channels 102 and multiple beamforming circuitries 108 that cooperate to form a single coherent beamformed signal (e.g., coherent beamformed signal 310). Coherent beamformed signal 110 from beamforming sensor node 100 and coherent beamformed signal 310 from secondary beamforming node 302 may be displayed digitally and/or converted into an analog signal for display.

In the embodiment of FIG. 2, beamforming sensor node 200 has three principal hardware components: a sensor array board 202, a signal conditioning and data acquisition and signal conditioning board 204, and a DSP board 206. Additionally, an auxiliary micro-controller board 208 may be used for sharing node data with a wireless sensor network. Elements that populate the data acquisition and signal conditioning board 204 include pre-amplifiers and filters, analog-to-digital converters, precision voltage references, and digital input-output lines. Signal conditioning (amplification and low-pass anti-aliasing filters) are used to maximize the dynamic range of the system and maintain the highest possible signal resolution after converting the analog sensor signals to digital signals, as is common practice in sampled-data systems.

In the example of FIG. 2, sensor array board 202 is configured with microphones; however, other sensor modalities, such as ultrasound transducers, may be used to detect pressure wave, and/or may be configured with other array geometries, without departing from the scope hereof. For example, the type of sensor and array geometry may be selected based upon the intended use of beamforming sensor node 200.

FIG. 4 is a schematic illustrating one exemplary distributed parallel beamforming system 400 with sixteen beamforming sensor nodes 402, four secondary beamforming nodes 404, and one tertiary beamforming node 406. Beamforming nodes 404 and 406 may each contain beamforming circuitry 108. Secondary beamforming node 404(1) beamforms coherent beamformed signals received from beamforming sensor nodes 402(1)-(4); secondary beamforming node 404(2) beamforms coherent beamformed signals received from sensor nodes 402(5)-(8); secondary beamforming node 404(3) beamforms coherent beamformed signals received from sensor nodes 402(9)-(12); and secondary beamforming node 404(4) beamforms coherent beamformed signals received from sensor nodes 402(13)-(16). In turn, tertiary beamforming node 406 beamforms coherent beamformed signals from secondary beamforming nodes 404(1)-(4) to form a single coherent beamformed signal. Tertiary beamforming node 406 may be one of: a computer, another beamforming sensor node, a DSP, a microcontroller, and an FPGA or ASIC signal processor of the same type used to implement beamforming circuitry 108 of beamforming sensor node 100.

The distributed model of sensor nodes and beamforming nodes, exemplified in FIG. 4, may be implemented to an arbitrary number of layers (i.e., more than the three shown) permitting a very large number of pressure wave sensors 120 within the system. Moreover, sensor nodes 402 may be arranged geometrically such that the combination of individual nodes forms a regular array pattern of an arbitrary geometry, such as a linear array, rectangular array, circular array, or three-dimensional array with desired and regular spacing between sensors in one to three dimensions.

FIG. 5 is a schematic showing one exemplary signal path 500 for a processing channel (such as processing channel 102 of beamforming sensor node 100, FIG. 1). Signal path 500 includes a serial peripheral interface (SPI) interface 502, a first-in-first-out (FIFO) buffer 504, hardcoded delays 506, and a comparator 508. Signal path 500 represents the portion of processing channel 102 that is implemented within beamforming circuitry 108. More specifically, signal path 500 represents delay circuit 104. Signal path 500 is thus similarly repeated for each other processing channel 102 such that each signal path 500 operates in parallel and contributes to the input of a summation block 510. Summation block 510 represents summer 128 of beamforming circuitry 108 for example. The summed signal output of summation block 510 is further processed by a cascaded integrator-comb (CIC) filter 512 and a finite impulse response (FIR) filter 514 that are connected in series and cooperate to produce coherent beamformed signal 110.

In order to achieve real-time throughput, the detected signals are processed through parallel signal paths 500 that are synchronized such that appropriately delayed signals are summed coherently within summation block 510. In one embodiment, digital signal processing is implemented using a field programmable gate array (FPGA) or ASIC whereby each a signal path 500 is created and subsequently replicated in hardware, e.g., through VHDL code.

The analog signal from each sensor is electronically conditioned and then converted to digital using an analog-to-digital converter (ADC) 126, wherein the sample rate is limited only by the conversion rate of the ADC. In the example of FIG. 5, the conversion rate is shown as 1 MHz. Higher conversion rates may be obtained by using faster ADCs.

Digital signal 103 is received from ADC 126 by SPI interface 502 and is passed into FIFO buffer 504. A coded delay 506, represented as a number of samples, is loaded to FIFO buffer 504 to delay digital signal 103. The number of samples is directly related to (a) the sensor position within the geometry of sensor array 101, (b) the size of sensor array 101, (c) the sampling frequency (e.g., 1 MHz), and (d) the location in space on which the array is focused. The coded delay for each signal path 500 defines a direction in which the beam is pointed, relative to the array of sensors.

Memory associated with FIFO buffer 504 is limited and thus the number of samples to delay the samples data is limited. Integrated system design of the sensor array geometry and sampling frequency achieves the required beam pattern and system bandwidth without violating limits of memory size associated with FIFO buffer 504.

FIG. 7 shows exemplary use of an adaptive filter 706 within a signal path 700. Signal path 700 may be used in place of signal path 500 and represents an alternate embodiment of a delay circuit (e.g., delay circuit 104 of processing channel 102, FIG. 1, that is implemented within beamforming circuitry 108). When time delays are unknown, adaptive filter 706, such as disclosed in Reed et al., “Time Delay Estimation Using the Least Mean Square (LMS) Adaptive Filter”—Static Behavior”, IEEE Transactions on Acoustics, Speech and Signal Processing Volume ASSP 29(3), June 1981, or subsequent art, is used to estimate the number of samples delay adaptively.

FIG. 6 shows one exemplary LMS filter schematic 600 for beamforming system with two processing channels, with sensor signals X₁ and X₂ in which the delay associated with signals reaching each transducer is estimated by adapting the weights of an FIR filter and estimating the delay by associating it with the index of the maximum of the weight vector. As shown in FIG. 7, adaptive filter 706 is implemented in parallel for each delay to be estimated, and the sample delay is then loaded into FIFO buffer 504 for each signal path 700.

In particular, FIG. 6 shows exemplary use of an adaptive LMS filter 602 for estimating the delay between two signals, where X₁ is a vector containing samples of a signal recorded from a first sensor within the sensor array, and X₂ is a vector containing samples of a signal from a second sensor of the sensor array and with unknown delay Δt between the arrival of the sensed signal at the first sensor and the arrival of the sensed signal at the second sensor. These vectors are of length N. The LMS filter models the delay as a finite impulse response filter of length N, with the output of the filter \hat{X}₂ being an estimate of the signal X₂ given by \hat{X}₂=W^{T}X₂. W is a weight vector estimated adaptively based on the signals X₁ and X₂ using a least-mean-squared (LMS) adaptive filter or one of its variants. The index associated with the maximum value of W times the sample time provides an estimate of Δt.

FIG. 8 shows a first graph 802 where line 804 represents a first raw recorded data signal and line 806 represents a second raw recorded data signal with delay of X₂ with respect to X₁ that is assumed unknown a priori. Graph 820 shows line 804 representing X₁ superimposed with a line 822 representing Xh₂=\hat{X}₂, where Xh₂ is shifted in time by the delay estimated by the LMS filter.

In FIG. 7, an LMS filter provides one embodiment of adaptive filter 706, which has the two signals digitized using two A-D converters (ADC2 702(1) and ADC1 702(2)) as inputs, performs the delay estimation, and the estimated delay is then loaded to a FIFO buffer 704 to delay signal X₂ so that it adds coherently to X₁.

Note that an additional benefit of using an LMS filter is that of filtering the signals prior to beamforming, further enabling improvement in signal-to-noise ratio. FIG. 9 shows one exemplary signal processing path 900 for processing digitized data signals from two sensors of the sensor array and incorporated an LMS filter within LMS delay estimation block 906 for estimating the delay between signals X₁ and X₂, where beamforming of the signals is performed using the LMS filter estimated signal and synchronization of the parallel signal processing paths through a FIFO buffer 904 is accomplished using an output of LMS delay estimation block 906. Signal processing path 900 represents an alternate embodiment of delay circuit 104 that is similar signal path 500 of FIG. 5, but wherein the LMS filtered output \hat{X}₂ is delayed and added coherently with X₁, and the LMS filter provides the synchronization signal for FIFO buffer 904 as described below.

The number of channels that may be implemented on a single node is limited only by the number of input channels that may be constructed using gates on an FPGA or ASIC device and associated memory for storing the delays. On a typical low-power FPGA device, memory and size of the device may permit up to 48 channels using current technology, such as a Xyling Spartan-3A and on a high-power device such as a Xylinx Virtex-7, 300 channels may be implemented in parallel. In order to support real-time adaptive filtering and issues associated processing noisy sensor measurements with traditional LMS filters, a leaky LMS filter, such as that disclosed within U.S. Pat. No. 6,741,707 (Method for Tuning and Adaptive Leaky LMS Filter) may be used for delay estimation.

Additional details of the embodiments of FIGS. 5, 7, and 9 using an FPGA are described below. Samples acquired from each channel in a beamforming array node are pipelined at the throughput frequency to first-input first-output (FIFO) registers which are implemented in the Block Random Access Memory (RAM) available on-chip. For the exemplary acoustic beamforming sensor node 200 of FIG. 2, in which the throughput frequency is 1 MHz and FPGA clock frequency is 50 MHz, these FIFO buffers 504, 704, 904 are 1K in depth with word length of 16 bits. In the embodiments of FIGS. 5 and 7, FIFO buffers 504, 704 are enabled (e.g., written to) by SPI interfaces 502, 702, respectively, and in the embodiment of FIG. 9, FIFO buffer 904 is enabled by LMS delay estimation block 906.

FIFO buffers 504, 704, 904 are capable of counting the number of data samples they hold. FIFO buffers 504, 704, 904 start reading out their data only when counting thresholds corresponding to input time-delays are met.

In one example of operation, a beamforming system (e.g., system 300 of FIG. 3) defines the counting thresholds through knowledge of the location of interest, i.e., range and angular direction relative to the sensor array, which correspond to time delay sets or vectors specifying the delay between each sensor for each location of interest. These sets may be stored in FPGA memory (e.g., within beamforming circuitry 108) and recalled automatically, in a specified sequence for scanning an environment or recalled based on a human operator's selection of location of interest. These two parameters (range and angular direction), together with the fixed effective sampling time of the processor, array geometry, spacing between the pressure wave sensors (e.g., microphones), and speed of pressure waves through the carrying media (e.g., sound through air) enable the system to resolve the temporal and spatial characteristics of the signals received through the pressure wave sensors (e.g., pressure wave sensors 120) in the sensor array (e.g., sensor array 101). When counting thresholds are reached, the FIFO buffers read out their samples continuously and synchronously, and the channels become aligned to add the sensor signals constructively.

Manipulating the counting thresholds a priori enables the system to time-delay the signals for pre-defined durations. These durations are also dependent on the effective sampling frequency of the processor. For example, with an effective sampling rate of 1 MHz, a unit-sample delay (a unit-threshold) corresponds to a time-delay of 1 microsecond.

As shown in FIGS. 5, 7, and 9, the samples of each processing channel undergo a two-stage filtering process. The first stage is a three-stage cascaded integrator-comb (CIC) filter 512, 712, and 912, followed by a second stage of low-pass finite impulse response (FIR) filter 514, 714, and 914, respectively. Together, these filters provide a decimation factor of 10.

Signals from each processing channel are summed and then scaled appropriately. This scaled signal, representing the beamformed output, may then be presented to the user or transmitted wirelessly or through a wired connection to an independent digital signal processor (e.g., secondary beamforming node 302, FIG. 3) as described above. An acoustic signal may be played through a D/A converter and audio amplifier on the node, or the beamformed output may be transmitted directly or through an auxiliary microcontroller for wireless communication with a central computer, e.g., a laptop, or the signal may be transmitted through a wired or wireless connection to the signal processor of another beamforming node (e.g., secondary beamforming node 302, FIG. 3) that receives similar signals from other nodes and sums the beamformed signals from each node, appropriately delayed based on node position.

For acoustic beamforming, the beamformed signal throughput is, for example, 100 KHz and may be up to 1 MHz, easily covering the ˜16 kHz bandwidth needed for speech communication. This is a direct consequence of the parallel architecture and implementation of the system. Beamforming acoustic signals at such a high frequency allows a high cutoff frequency for analog anti-aliasing filters, minimizing phase difference in each signal phase attributed to differences in manufacturing tolerances on analog circuitry components. For example, a 20-30 kHz anti-aliasing filter may be used in the signal path of FIG. 1, allowing matching of the filters and minimizing phase error attributed to the filters within the speech communication band.

Also, each processing channel includes selectable gains and active filters to maintain the maximum dynamic range possible and avoid signal aliasing. Configurability is achieved by varying the counting thresholds and filter coefficients across the different channels. For sound capture in acoustic beamforming nodes, the embodiment of the system shown in FIG. 2 uses Micro-Electro-Mechanical Systems (MEMS) microphone assembled on a printed circuit board. Notable advantages of such microphones include tighter manufacturing tolerances on the frequency response of the microphones. Thus, in theory, when compared to commodity electrets-microphones, MEMS microphones have substantial less frequency response variations across different samples.

In the example of FIG. 2, a sensor array board 202 has 24 MEMS microphones—twelve equally spaced microphones populating each of two circles of 10 cm and 15 cm in radius, respectively. FIG. 10 shows exemplary beam patterns 1000 corresponding to the two radii configurations for two frequencies: 500 Hz and 3000 Hz. The larger radius offers better directivity at lower frequencies. At higher frequencies, it offers narrower beam-width for the location monitored but it also introduces significant grating lobes in other directions corresponding to spatial aliasing. The smaller radius offers better directivity at higher frequencies. At lower frequencies, it does not offer adequate directivity, yielding low signal discrimination. While FIGS. 2 and 10 show exemplary embodiments of the array sensors and resulting directivity, the distributed parallel beamforming system described herein is not limited to any particular array geometry.

The delay set described above is a vector whose size equals the number of pressure wave sensors 120 in sensor array 101. The delay set maps a delay value to each individual processing channel 102. Delay values within the delay set are discrete values corresponding to a number of samples that digital signal 103 is to be delayed to remove phase related to time-of-arrival of a source signal (e.g., pressure wave) at each sensor such that the delayed signals collectively add coherently. For acoustic and ultrasonic beamforming, the delay set depends on the speed of sound in the medium; the “look” direction specified; the number of microphones in the node; the microphone array geometry, i.e., the relative locations of microphones in the node; and the effective sampling rate of microphone data, i.e., the rate at which microphone data is pipelined through the beamforming circuitry 108.

Since location and delay measurements are relative, the frame-of-reference for sensor locations is determined by the array geometry, e.g., the center of the circular node in the example of FIG. 2. Hence, a sensor's location is given by its coordinates relative the circle's center. The “look” direction is given either by its Cartesian or cylindrical coordinates. The algorithm that generates the delay set follows directly from mapping the separation distances between each sensor and the “look” location into sample-based delays that may be encoded in hardware to synchronize the sensor data. This mapping is based on the relationship d=ct where d is the distance that the source propagates before impinging on the sensor, t is the elapsed time, and c is the speed of sound in the medium. The elapsed time values are used to calculate the time-difference of arrival between the sensors given the source location. The algorithm picks the sensor that last captures the waves propagating from the “look” or source location as the reference sensor. This choice of reference is owing to the fact that the sensor that is closer to the “look” location will capture acoustic waves first, whereas the sensor that is furthest from the “look” location will capture acoustic waves last. Because the beamforming system must be causal, i.e., because the beamformed signal depends on past and present events, and not on future events, the system needs to appropriately delay each sensor's data so that it is synchronous with the sensor that last captures the sound source. Hardware or digital implementation of these delays requires conversion from times to equivalent sample-based values by scaling the time-values by the effective sample frequency of the sensor data. An exemplary delay computation table 1100 is shown in FIG. 11 for a circular node of radius 10 cm and a “look” location that is 10 m from the node's center. The maximum delay of 589 samples easily fits within the 1K FIFO buffer.

The resolution of the beamforming process is influenced by many factors. The phase characteristics of the sensors and the physical components in the system are the dominant factors. Other factors include the uncertainty in the relative separation between the system's array and the source, the degree to which a sound source may be assumed a “point” source and a 3-D environment may be approximated by a 2-D environment, the sample frequency of the microphone signals and the digital processor. The following will discuss the signal processing, “digitization”, effect on resolution. The delay set is expressed as integer sample values and thus is digitized given the delay times through converting time-based delay values into sample-based delay values rounded to the nearest integer; thus rounding affects the resolution of the beamforming circuitry 108.

Analysis to determine angular resolution, range resolution, and area resolution shows that the rounding of time-based delay valued into sample-based delay values has minimal impact on resolution. Angular resolution is defined as an angular change that has to occur in the “look at” location before the delay set changes. Range resolution is defined change in the distance between the “look” point and the node's center, before the delay set changes. When examining the angular resolution, range is fixed, and when examining the range resolution, angle is fixed inferring an approximate area resolution. For the example above with circular beamforming node looking at a point 5 meters away, the angular resolution is 0.06 degrees and range resolution is 0.6 m for sensors with node radius 10 cm and sample frequency of 1 MHz providing an approximate area resolution of 34 square cm. This analysis shows that other effects, e.g., unknown phase error inherent in the system electronics, and not resolution of delay set, will dominate performance of beamforming sensor node 100.

Integer number of samples that comprise the delay sets are translated into hardware registers for temporary storage. Therefore, we determine the maximum sample delay that exists in all possible delay sets to ensure that the beamformer is not hardware-limited. Since the beamformer is designed with a priori knowledge of available memory resources (registers) per sensor in the array, software is designed to sweep candidate “look” locations and report the maximum memory requirement found. Such a memory requirement forms the upper bound on memory needed for any sensor in the array. This maximum memory requirement is influenced by the array geometry and the signal processing rate for recorded data. Exemplary results for circular array examples described above shows that the maximum memory (589 samples) is less than the 1024 storage locations within the FIFO buffer.

FIG. 12 shows one exemplary microphone pre-amplifier circuit 1200 that utilizes a precision reference voltage circuit 1300 shown in FIG. 13. Signal conditioning circuitries 124 are provided for each pressure wave sensor 120 in the sensor array 101. The gains across each circuit and frequency response of each circuit are consistent so that signal variations between each pre-amplifier are attributed solely to time-of-arrival differences of the sensed pressure wave signal. This consistency is achieved by providing a precise reference voltage at the non-inverting terminals of the operational amplifiers using a dedicated low-impedance, shunt voltage regulator with a reference voltage of 1.65V (see precision reference voltage circuit 1300 of FIG. 13). This reference is fed to all the non-inverting terminals through a dedicated PCB-layer section in the embodiment of FIG. 2. There remains the variation between discrete-elements that are used in the operational amplifiers, since discrete-elements have tolerance values ranging from 1% to 20%. As the phase of these pre-amplifier circuits will vary most at the corner frequency of the circuit, as described above, the corner frequency of this circuit may be selected to achieve the desired bandwidth of operating while avoiding addition of phase error owing to variation between analog circuitry attributed to normal tolerances on passive components. For example, when sampling at 1 MHz for an audio system with a required bandwidth of 10 kHz allows placing the corner frequency well above 20 kHz so as to minimize degradation in beamforming performance within the band of interest.

Each pressure wave sensor 120 in the sensor array 101 uses an ADC 126 of sufficient resolution and signal-to-noise ratio so as to facilitate high bandwidth sampling of the signal from pressure wave sensor 120. FIG. 14 shows one exemplary analog-to-digital conversion circuit 1400 that uses a low-power, 16-bit, 1 MHz converter for each sensor, with each converter using logic lines to facilitate data transfer through an SPI interface. FIG. 15 shows one exemplary precision, low-dropout voltage reference circuit that generates a reference voltage that is applied to a reference voltage terminal of the ADC.

Beamforming signal paths are synchronized to reduce phase errors due to inherent latencies between ADC conversions. Some of the conversion and control logic signals are identical for each ADC and may be physically shared by the ADCs. The ADCs are vertically laid out on the PCB and are separated by a known distance. Thus, in writing the VHDL SPI interface, careful consideration is given to the possible signal latencies of the ADC control signals. Some of the common signals include the Serial Clock (SCLK) and Conversion Start (CONVST) signals. These common signals are provided by the FPGA as signal lines routed (physically shared) by all ADCs, which requires current- and voltage-limit analysis; the DSP is capable of sourcing a maximum current across these signal lines, but the ADCs together may require additional current. Furthermore, due to any serial resistance and the combined capacitive load attributed to the ADCs, control signals might not be able to change between their high and low levels in a timely-fashion. Hence, a buffer stage is incorporated to compensate for both current- and voltage-limited situations. FIG. 16 shows one exemplary buffer configuration 1600. Beamforming sensor node 200 of FIG. 2 has a 50 MHz (20 ns) operation, and therefore these integrated circuits have acceptable time specifications, with a maximum propagation delay of 5.1 ns and a switching time of less than 2.5 ns (with a capacitive load of 50 pF). Beamforming sensor node 200 utilizes 69% of the maximum possible current.

The use of FIFO buffers and parallel signal processing paths for pipelining data through adaptive filters for time delay estimation and for beamforming eliminates a substantial component of the data management problem that exists for systems with high throughput and a large number of channels. Data from individual sensors are never stored in memory and do not require external electronic elements, such as a DMA controller or graphical processing unit to manage the data. For each node (e.g., beamforming sensor node 304 of FIG. 3) of the beamforming system (e.g., system 300) described herein, only the beamformed signal (e.g., coherent beamformed signals 110, 310) is retained for further processing or display. When retained for further processing, the signal is streamed, either wirelessly or by wired connection, to a computer, microcontroller, or to a secondary beamforming node (e.g., secondary beamforming node 302) containing an FPGA or ASIC of the same architecture, thus it continues to be pipelined through parallel signal processing paths until all nodes are beamformed into a single signal; hence, only the single beamformed signal is retained for display or storage. For a 10 MHz ultrasound system with 256 elements, this reduces data to be managed for each location scanned from 5.12 GB/sec to 20 MB/sec.

Both objective (improvement in signal to noise ratio) and subjective (speech intelligibility) measurements have been used to evaluate an exemplary beamforming system using distributed parallel processing. For computation of SNR improvement, compared with a single microphone recording, data are recorded simultaneously for the beamformed output, and for a “single-microphone” output in a free field environment. These data sets are recorded simultaneously with 24-bit resolution and 100 KHz sampling rate. Using the beamforming system, date are collected to perform SNR computations across different sound levels and across different sound stimuli, namely narrowband sources (pure tones at 1 octave center frequencies), and broadband sources (speech).

FIG. 17 shows a first experimental configuration 1700 with a single beamforming node 1702 that is positioned 3 meters from a speaker 1704. FIG. 18 shows a second experimental configuration 1800 with two beamforming nodes 1802(1)-(2) positioned 3 meters and 3.34 meters from a speaker 1804, respectively. Nodes 1702 and 1802 may represent one of nodes 100, 304, and 402. Tone data sets were 1.75 seconds in duration. Speech data sets were 10.49 seconds in duration. The SNR analysis measures beamforming performance from a power prospective, and compares the measured values to the theoretical values for a 12-channel beamforming system. A single beamforming node with 12 microphones has a theoretical SNR improvement of 10.8 dB and a system of two beamforming nodes has a theoretical SNR improvement of 13.8 dB. Experimental results show improvement of SNR for a single beamforming node of 8.6-10.0 dB for pure tone sources and 9.7 dB for a voice source. For a two-node system, improvement of SNR of 11.3-12.5 dB was measured. These results demonstrate over 87% of theoretical maximum increase in SNR is recovered through distributed, parallel beamforming.

Speech intelligibility is evaluated using a variant of the Modified Rhyme Test (MRT) (American National Standards Institute. 1989). American national standard method for measuring the intelligibility of speech over communication systems (ANSI S3.2-1989—A revision of ANSO S3.2-1960). New York: American Standard Association). In evaluation of over 30 subjects, an improvement in speech intelligibility of 17% was measured.

FIG. 19 shows exemplary determination of beam angles and distances for a beamforming system 1900 (e.g., a beamforming acoustic binocular) with two beamforming sensor nodes 1902(1), 1902(2), that are remotely located from a secondary beamforming node 1904. However, it should be noted that a single beamforming sensor node may also operate as an acoustic binocular. Each beamforming sensor node 1902 communicates wirelessly with secondary beamforming node 1904. Secondary beamforming node 1904 may include a digital processor and software that includes algorithms for calculating delay vectors 1920(1) and 1920(2) for each of sensor nodes 1902(1) and (2) to steer beamforming of each sensor node towards pressure wave source 1906. In FIG. 19, each beamforming sensor node 1902 and secondary beamforming node 1904 is aligned to the same reference direction 1908 (e.g., a compass direction). In an alternative embodiment, sensor nodes are not aligned and each sensor node identifies the source location, range and angle, relative to its own coordinate system. Sensor node 1902(1) is at angle A(1) and range R(1) from secondary beamforming node 1904 and sensor node 1902(2) is at angle A(2) and range R(2) from secondary beamforming node 1904. Pressure wave source 1906 is located at angle A(3) and range R(3) from secondary beamforming node 1904.

Based upon standard trigonometry, a “look” location relative to sensor node 1902(1) is determined as angle A(4) and range R(4). Given size and geometry of sensor array 101 of sensor node 1902(1), a delay vector 1920(1) is calculated and sent to sensor node 1902(1). Similarly, a “look” location relative to sensor node 1902(2) is determined as angle A(5) and range R(5). Given size and geometry of sensor array 101 of sensor node 1902(2), a delay vector 1920(2) is calculated and sent to sensor node 1902(2).

Beamforming sensor node 1902 sends a coherent beamformed signal 1930(1) to secondary beamforming node 1904 and sensor node 1902(2) sends a coherent beamformed signal 1930(2) to secondary beamforming node 1904. Within secondary beamforming node 1904, beamforming circuitry 108 generates a delay vector to delay coherent beamformed signals 1930(1) and 1930(2) based upon range R(4) and range R(5), respectively, such that a single coherent beamformed signal 1950 is output from secondary beamforming node 1904. Thus, beamforming system 1900 operates as a steerable acoustic “binocular”.

As shown in FIG. 1, beamforming circuitry 108 optionally includes a beam controller 150 that operates to control delays implemented by delay circuit 104 to select a beam angle and/or range for beamforming sensor node 100. Although shown within beamforming circuitry 108, beam controller functionality may, at least in part, be implemented external to beamforming circuitry 108, such as within software of a hosting device. Beam controller 150 may communicate, via communication module 130 for example, with one or more of a secondary beamforming node, a user (e.g., using an interactive user interface) or other hosting device, to select the beam angle and/or range to “look” at a specific pressure wave source. For example, in the embodiment of FIG. 5, hardcoded delays 506 may define multiple time delay sets or vectors for a plurality of different beam angles and ranges, wherein beam controller 150 selects one time delay set or vector based upon received beam control information. In the embodiment of FIG. 7 for example, beam controller 150 may identify a first pressure wave sensor 120 of the sensor array 101 that is furthest from a desired “look” location, wherein adaptive filter 706 within each other processing channel 102 operates to estimate the time delay for that channel relative to a signal X1 from the identified first pressure wave sensor 120.

Beam angle and range may be specified relative to a known orientation of beamforming sensor node 100, or relative to a determined orientation of beamforming sensor node 100. For example, where beamforming sensor node 100 is implemented with a portable device (e.g., a smartphone), the portable device may determine and report the orientation of sensor array 101 to at least beam controller 150.

In one example of operation, beam controller 150 interacts with a user to receive a location of a user selected audio source, wherein beam controller 150 first calculates a beam angle and range, and then determines a delay set or vector that configures beamforming sensor node 100 to “look” at the selected pressure wave source. Multiple beamforming sensor nodes 100 may be similarly controlled to cooperate and “look” at the same source irrespective of their relative locations to one another.

In another example of operation, beam controller 150 operates to control delay circuit 104 to automatically switch between a plurality of time delay sets or vectors to “sweep” the beam between each of a plurality of beam angles and ranges to locate a specific pressure wave source. Thus, a listener may sweep the beam angle through a selected and/or predefined set of angles and ranges to locate and listen to a particular audio source.

FIG. 20 shows one exemplary system 2000 for enhancing sound collection. System 2000 includes a first and second mobile device 2002(1) and 2002(2) (e.g., a smartphone) are each configured with a beamforming sensor node 100 that includes an adaptive filter (e.g., adaptive filter 706) for estimating a delay to correct phase shift between pairs of signals from pressure wave sensors (e.g., microphones) of that node. That is, within each mobile device, beamforming sensor node 100 automatically generates a coherent beamformed signal 2008 based upon detected sound from sound source 2010. Each device 2002 transmits the beamformed signal 2008(1) and 2008(2) to a server and/or secondary beamforming node 2004. Secondary beamforming node 2004 includes beamforming circuitry 108 and also includes an adaptive filter for estimating a delay between received coherent beamformed signals 2008 to generate a single coherent beamformed signal 2020 therefrom.

In one exemplary embodiment, server 2004 independently controls beamforming angle and range of each beamforming sensor node 100 by sending the angle and range information to each smartphone 2002. In another exemplary embodiment, beamforming node 2004 operates to control beam angle and range of each beams of beamforming sensor nodes 100 and beamforms signals 2008 to improve signal to noise ratio of signal 2020 which is representative of sounds from source 2010.

Where beamforming sensor node 100 is implemented on a smartphone 2002, server and beamforming node 2004 may operate to collect coherent beamformed signals 2008 based upon social grouping of smartphones 2002.

Beamforming sensor node 100 and optional secondary beamforming nodes 302 may be used in many market areas, For example, where pressure wave sensors 120 operating in the ultrasound spectrum, beamforming sensor node 100 may be used in one or more of: ultrasound scanning medical devices, to perform nondestructive evaluation, and within stethoscope devices. Beamforming sensor node 100 and optional beamforming nodes 302 may be used in law enforcement for audio surveillance such as to selectively listening in on a particular conversation. For example, a device may be positioned on or within a building and configured to automatically sweep the beam through each of a plurality of angles and ranges to selectively listen to specific locations.

Although circuits 104/108 of beamforming sensor node 100 has a plurality of parallel digital signal processing paths, these circuits may be implemented using integrated circuitry and is therefore relatively small in size, as compared to the sensor array 101, and is also relatively low in cost. Thus, multiple beamforming sensor nodes and beamforming nodes may be use together in both a cost effective way and without physical limitations due to node size.

In a preferred embodiment, sensor array 101 is circular. However, other geometries may be used for sensor array 1010 without departing from the scope hereof. In particular, where the range of angles of the beam is restricted by other constraints (e.g., physical locations or intended use), other geometries may be preferred.

For certain uses, distinct advantages are found by utilizing multiple strategically positioned beamforming sensor nodes 100 and one or more levels of secondary beamforming nodes, since each level of secondary beamforming node further increases the signal to noise ration of the resulting single signal.

As shown in FIG. 12, each processing channel 102 includes “on-node” signal conditioning. For example, sensor array 101 and respective preamplifiers/gain circuitry 122, signal conditioning circuitries 124 and ADCs 126 may be optimally configured on a single circuit board, together with the associated beamforming circuitry 108 resulting in a minimal connectivity requirement, since a single signal is output.

Coherent beamformed signal 110 and 310 is conveniently in a digital format, but is easily converted to analog format for output and both analog and digital formats are easily displayed.

Although the description provided herein focuses primarily on beamforming with arrays receiving signals from microphones and ultrasonic transducers, principals described herein for distributed processing apply also to transmission of a beamformed signal from an array of ultrasonic transducers or speakers.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A beamforming sensor node, comprising:
an array of pressure wave sensors, each pressure wave sensor configured within a unique processing channel including a time delay circuit for producing a signal, with a phase offset, representative of received pressure waves at said pressure wave sensor;
beamforming circuitry, including time delay circuits for all processing channels, for (a) setting the phase offset of each processing channel and (b) parallel processing all signals from the array of pressure wave sensors through respective time delay circuits to form a first coherent beam-formed signal from the node.

2. The beamforming sensor node of claim 1, the time delay circuit comprising a FIFO buffer responsive to the beamforming circuitry to delay the signal by a number of clock cycles based upon size and geometry of the array of pressure wave sensors.

3. The beamforming sensor node of claim 1, the beamforming circuitry comprising one of an FPGA, ASIC and DSP that adaptively processes signals from the array of pressure wave sensors to estimate and implement phase offset for each sensor of the array.

4. The beamforming sensor node of claim 3, the beamforming circuitry implementing a LMS filter for estimating time delay between pairs of signals from the pressure wave sensors, to set the time delay circuit for each of the pressure wave sensors.

5. The beamforming sensor node of claim 1, the beamforming circuitry and time delay circuits being implemented as an integrated circuit.

6. The beamforming sensor node of claim 1, further comprising a wireless transducer for wirelessly communicating the first coherent beam-formed signal to an external receiver that also wirelessly receives a second coherent beam-formed signal from a second beamforming sensor node.

7. The beamforming sensor node of claim 1, wherein the first coherent beamformed signal is a single signal.

8. A pressure wave binocular, comprising:
a plurality of sensor nodes and at least one secondary beamforming node, each sensor node comprising beamforming circuitry and an array of pressure wave sensors, each pressure wave sensor configured within a unique processing channel including a time delay circuit for producing a signal, with a phase offset, representative of received pressure waves at said pressure wave sensor, wherein the beamforming circuitry includes time delay circuits for all processing channels, for (a) setting the phase offset of each processing channel and (b) parallel processing all signals from the array of pressure wave sensors through respective time delay circuits to form a coherent beam-formed signal from the node, wherein the secondary beamforming node combines coherent beam-formed signals from the plurality of sensor nodes to produce a combined acoustic signal representative of received pressure waves at all sensor nodes.

9. The pressure wave binocular of claim 8, further comprising a communications link between each one of the sensor node and the secondary beamforming node.

10. The pressure wave binocular of claim 9, the communications link comprising one of a wired and a wireless data communications link having 1/N data as compared to data produced by all N sensors of a node.

11. The pressure wave binocular of claim 8, the pressure wave sensors from each of the sensor nodes comprising microphones.

12. The pressure wave binocular of claim 8, the pressure wave sensors from each of the sensor nodes comprising ultrasonic transducers.

13. The pressure wave binocular of claim 8, the beamforming node comprising means for communicating with the sensor nodes to sweep through phase offsets and directionally focus on different sources of the pressure waves.

14. A beamforming acoustic binocular node, comprising:
a smartphone having an array of acoustic sensors, each acoustic sensor configured within a unique processing channel including a time delay circuit for producing a signal, with a phase offset, representative of received sounds at said acoustic sensor; and
beamforming circuitry, including time delay circuits for all processing channels, for (a) setting the phase offset of each processing channel and (b) parallel processing all signals from the array of acoustic sensors through respective time delay circuits to form a first coherent beam-formed signal from the node.

15. Social acoustic beamforming system, comprising:
a plurality of smartphones and at least one secondary beamforming node, each of the smartphones comprising beamforming circuitry and an array of acoustic sensors, each acoustic sensor configured within a unique processing channel including a time delay circuit for producing a signal, with a phase offset, representative of received sounds at said acoustic sensor, the beamforming circuitry, including time delay circuits for all processing channels, for (a) setting the phase offset of each processing channel and (b) parallel processing all signals from the array of acoustic sensors through respective time delay circuits to form a first coherent beam-formed signal from the node, the secondary beamforming node combining all coherent beam-formed signals from the plurality of smartphones to produce a combined acoustic signal representative of received acoustic waves at all smartphones.
